(19) United States
(12) Patent Application Publication
(10) Pub. No.: US 2003/0095755 A1
(43) Pub. Date: May 22, 2003

(54) Feature and method to align and assemble photonic components

(76) Inventors: Vladimir Vaganov, Los Gatos, CA (US); Ching Chu, Sunnyvale, CA (US); Michael Peter Kohlstadt, San Jose, CA (US)

Correspondence Address: PATRICK REILLY, MEGASENSE, 1215 BORDEAUX DRIVE, SUNNYVALE, CA, 94089, US

(21) Appl. No.: 09/991,226

(22) Filed: Nov. 16, 2001

(51) Int. Cl. G02B 6/42; G02B 6/36

(52) U.S. Cl. 385/88; 385/92; 385/93; 385/52

(57) ABSTRACT

An apparatus and method to align and assemble a photonic package with sub-micron placement accuracy. The apparatus, or feature, maintains mechanical contact between a first and a second photonic component while the two photonics are aligned and affixed together. The package may comprise the first photonic component having a contact surface and the second photonic component having a partially spherical surface. The contact surface is shaped and fitted to rotatably couple with the partially spherical surface while permitting the partially spherical surface to move in at least three rotational degrees of freedom. The two photonic components are then aligned as desired and affixed together. Certain variations permit motion of the partially spherical surface in three rotational degrees of freedom and one linear degree of freedom. At least one version of the invention includes aligning and assembling an optical fiber with an optical MEMS-based device. In this version, the partially spherical surface of the second component may be coupled with the optical fiber first and makes contact with a contact surface of the MEMS-based device. The optical fiber is then rotated in two degrees of freedom until a desired alignment with the MEMS-based device is achieved. The optical fiber and the MEMS-based device are then affixed by affixing the partially spherical surface and the contact surface together. In one alternate variation the partially spherical surface is shaped to make contact with a contact area of the contact surface. The partially spherical surface maintains connection with at least part of the contact area while the partially spherical surface is rotated in at least two rotational degrees of freedom.

### BACKGROUND OF THE INVENTION

1. Field of the Invention

The present invention relates generally to methods of aligning and assembling photonic components together. More particularly, this invention is relates to methods of forming photonic packages by aligning and assembling optical or photonic components together for use in an optical communications system or network.

2. Discussion of the Related Art

Certain prior art photonic package or devices have photonic components assembled together for transmitting optical signals. Gilliland discloses, in “Optical Package with Alignment Means and Method of Assembling an Optical Package,” U.S. Pat. No. 5,812,717 (Sep. 22 1998), a bore in a first housing of a first component that receives and aligns a ball lens. The bore and the ball lens are aligned with a focusing element and a substrate along a common axis. The focusing element is adjacent to the bore. Gilliland teaches that an assemblage of inner and outer sleeves coupled with components of the optical package, may be formed and used in combination with a groove in the substrate to align the ball lens and the substrate. The complexity of Gilliland's invention, combined with its narrow scope of application, limits the technical and efficient application of the disclosed invention in the art of photonic or optical device design and fabrication.

Feuer et al. discloses, in “Fourier-Plane Photonics Package”, U.S. Pat. No. 5,857,048 (Jan. 5, 1999), a photonic device package requiring high accuracies of device component placement and orientation. Feuer et al. present a photonics device having two optical fibers held by a dual-fiber ferrule. The fibers are both positioned optically off-axis in reference to a single optical lens. An optical signal is transmitted from a first optical fiber, through the lens and to a photonic device. The photonic device thereupon transmits an optical signal to the remaining optical fiber. Feuer et al. teach that the photonic device is preferably at a Fourier plane relative to the two optical fibers. Feuer et al. thereby explain that the precision of an alignment of the ferrule and the optical fibers to the photonic device is critical to the efficiency and effectiveness of their invention. Yet Feuer et al., and the prior art, fail to provide efficient methods and features to simplify and improve the formation of photonic packages by precise aligning and affixing of combinations of photonic components.

It is sometimes necessary in the art to align and affix an optical fiber to an alternate photonic component type with sub-micron accuracy. The technology of optical communications involves the use of many photonic component types that must be aligned and assembled together to form photonic packages that maintain very specific orientations within very tight mechanical tolerances. What is needed is an improved method to highly accurately and precisely align and assemble two photonic components together, where the photonic components have either similar or diverse forms and functions.

It is therefore an object of the present invention to provide improved methods to construct photonic packages by precisely aligning and assembling at least two photonic components together.

### OBJECTS OF THE INVENTION

It is an object of the present invention to provide a method to form a photonic package by aligning and assembling at least two photonic components together.

It is another object of the present invention to provide a method to assemble a photonic package that enables the maintenance of mechanical contact between a first and a second photonic component while the two photonic components are aligned and affixed together.

It is an alternate or additional object of the present invention to provide a feature useful for aligning and assembling at least two photonic components together as a photonic package.

It is an object of certain preferred embodiments of the present invention to provide a method to align and assemble at least one optical fiber with at least one other photonic component.

It is another object of certain alternate preferred embodiments of the present invention to provide a feature useful for aligning and assembling at least one optical fiber with at least one other photonic component.

It is an additional or alternate object of certain other preferred embodiments of the present invention to provide a method useful for aligning and assembling at least one optical fiber with a VOA.

It is an object of certain alternate preferred embodiments of the present invention to provide a method useful for aligning and assembling at least one optical fiber with an optical switch.

It is yet another object of certain alternate preferred embodiments of the present invention to provide a method to align and assemble at least one photonic component with a MEMS-based photonic component.

It is a still alternate or additional object of certain yet alternate preferred embodiments of the present invention to provide a mechanical feature useful for aligning and assembling at least two photonic components, with positioning higher accuracy and reduced placement error, into a photonic package.

### SUMMARY OF THE INVENTION

In accordance with the teachings of the present invention, a feature of a photonic package having at least two photonic components and a method to align and assemble the at least two photonic components is provided. In a first preferred embodiment, a first photonic component has a first housing with a convex surface, such as a partially spherical surface, that rotatably couples with a contact surface of a second housing of a second photonic component. In alternate preferred embodiments the convex surface may be ovoid, ellipsoid or another suitable convex surface that couples with the contact surface of the second housing. For alignment and to aid assembly, the partially spherical surface of the first photonic component is inserted within, and at least partially enclosed by, the contact surface. The contact surface constrains linear motion of the partially spherical surface in at least two linear dimensions while allowing rotational motion of the first component about three orthogonal axes. The partially spherical surface is at least partially in mechanical contact with a contact area of the contact surface when movement of the partially spherical surface is constrained by the contact surface. The first component is then aligned while maintaining the rotational coupling of the partially spherical surface with the contact surface. The quality of an alignment may be evaluated by transmitting an optical signal between the first photonic component and the second photonic component and comparing the characteristics of a received optical signal with the characteristics expected of the optical signal received when the first photonic component and the second photonic component are optimally or desirably aligned. When the first component is satisfactorily aligned with, or properly oriented to the second photonic component, the partially spherical surface is affixed to the contact surface and the first and second component of the package is formed.

It is understood that an orientation or an alignment may be executed or achieved by moving the second optical component relative to the first optical component, or moving both optical components relative to each other. The alignment may occur by forming a seal line, or a contact area, at which the first and second optical components are in mechanical contact.

In various alternate preferred embodiments of the present invention the contact surface may have one or more of a plurality of shapes and features. In one alternate preferred embodiment of the present invention, the contact surface has an internal semispherical surface that is shaped and sized to at least partially enclose and constrain a partially spherical surface having a partially spherical shape. In another preferred embodiment of the present invention the contact surface has an internal conical or funnel surface that is shaped and sized to at least partially enclose and constrain a first photonic component having a partially spherical surface. In still another preferred embodiment of the present invention the contact surface, comprises a concave area of substantially partially spherical shape, wherein the concave area does not exceed a hemisphere in total shape or scope. The term para-spherical contact surface denotes herein a contact surface having a concave surface that comprises areas of substantially partially spherical shape, and wherein the contact surface does not exceed a hemisphere in total shape or scope. In yet another preferred embodiment of the present invention the contact surface has an internal cylindrical surface that is shaped and sized to at least partially enclose and constrain a partially spherical surface having a partially spherical shape. A still other preferred embodiment of the contact surface has an internal niche that accepts the partially spherical surface and limits the linear motion of the partially spherical surface in all three spatial dimensions. Alternately or additionally, the contact surface may have openings useful for delivering epoxy, adhesive, solder, or another suitable substance known in the art as useful for affixing the partially spherical surface and the contact surface together. The contact surface may have a thinned edge for better enabling an affixing of the first and second photonic components. The thinned edge is useful in brazing the contact surface to the partially spherical surface when applying electrical welding techniques. The contact surface may be located within a second housing of the second photonic component, whereby the partially spherical surface is inserted into the second photonic component prior to an insertion within the contact surface.

In yet other various alternate preferred embodiments of the present invention the contact surface comprises or is a domed wall that does not substantially enclose the partially spherical surface. In certain preferred embodiments of this type the partially spherical surface is sized and fitted to present a contact surface against an external surface of the domed wall, whereby the partially spherical surface may be rotated and optionally slid while maintaining contact with the external surface of the domed wall. The contact surface of the domed wall may be partially spherical or convex and the partially spherical surface may be shaped and sized to fit against the contact surface. Alternately or additionally, the domed wall or the partially spherical surface may have openings useful for delivering epoxy, adhesive, solder, or another suitable substance known in the art as useful for affixing the partially spherical surface and the domed wall together. The domed wall and/or the partially spherical surface may have a thinned edge for better enabling an electrical welding, brazing or affixing of the first and second photonic components. The domed wall or the partially spherical surface may offer three or more contact points that touch and guide the partially spherical surface along the contact surface. The domed wall may be located partially or wholly within the second housing of the second photonic component, whereby the partially spherical surface is inserted into the second housing of the second photonic component prior to making contact with the domed wall.

A photonic component as defined herein to optionally be or comprise a photonic element, such as a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a lens, a C-lens, a lens system, a mirror, a flat mirror, a shaped mirror, a diffractive mirror, a grating plate or plates, a laser, a modulator, a photodiode, a VCSEL, and a prism.

A photonic element or component may be substantially symmetric to an optical axis of its own or of an optical axis of another photonic element or component. Alternatively or additionally, a photonic component or element may be asymmetric to an optical axis of its own or of an optical axis of another photonic element or component.

The above summary of the present invention is not intended to describe each illustrated embodiment or every implementation of the present invention. The figures and the detailed description which follow more particularly exemplify these embodiments. Other objects, features, and advantages of the present invention will be apparent from the accompanying drawings and from the detailed description which follows below. The invention will now be elucidated in more detail with reference to certain non-limitative examples of embodiment shown in the attached drawing figures.

### BRIEF DESCRIPTION OF THE DRAWINGS

The present invention is illustrated by way of example and not limitation in the figures of the accompanying drawings, in which like references indicate similar elements, and in which:

FIG. 1 is a cross-sectional view of a first preferred embodiment of the present invention having a cylindrical contact surface.

FIG. 2 is a cross-sectional view of the first preferred embodiment of the present invention of FIG. 1 having a cylindrical contact surface with an internal niche

FIG. 3 is a cross-sectional view of a third preferred embodiment of the present invention having a conical contact surface.

FIG. 4 is a cross-sectional view of a fourth preferred embodiment of the present invention having a para-spherical contact surface, where the para-spherical contact surface is less than hemispherical in shape and scope.

FIG. 5 is a cross-sectional view of a fifth preferred embodiment of the present invention having a partially spherical contact surface into which a partially spherical surface snap fits.

FIG. 6 is a cross-sectional view of a sixth preferred embodiment of the present invention having a contact surface with a partially spherical domed wall.

FIG. 7 is a cross-sectional view of a seventh preferred embodiment of the present invention having a contact surface and a second contact surface, wherein each contact surface is used to align different photonic component.

### DETAILED DESCRIPTION OF A PREFERRED EMBODIMENT

While the description above provides a full and complete disclosure of the preferred embodiments of the present invention, various modifications, alternate constructions, and equivalents will be obvious to those with skill in the art. Thus the scope of the present invention is limited solely by the appended claims.

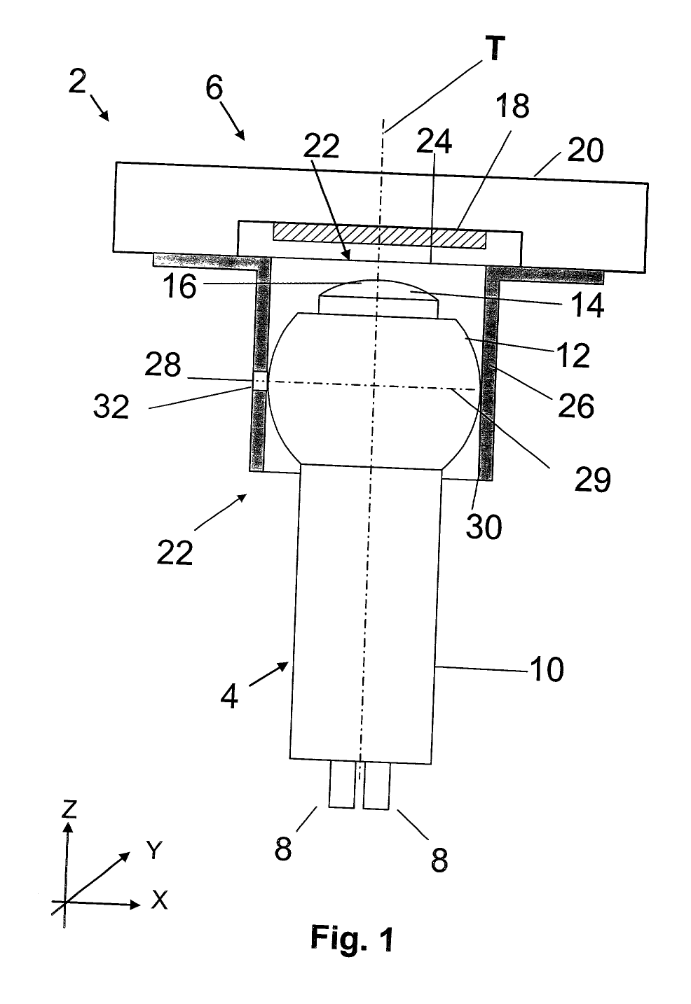

Referring now generally to the Figures and particularly to FIG. 1, a first preferred embodiment of the present invention, or photonic package 2. The photonic package 2 includes a first photonic component 4 and a second photonic component 6. The first photonic component 4 has an optical fiber 8 and a first housing 10 having a partially spherical surface 12. The partially spherical surface 12 is partially spherical and includes a first photonic opening 14. The first photonic opening 14 permits light to pass in and out of an endface 16 of the optical fiber 8. The second photonic component 6 has a MEMS optical mirror die 18, a second housing 20 and an access port 22. The second housing 20 is coupled to the MEMS optical mirror die 18, or MEMS die 18, and substantially encloses and protects the MEMS die 18. The access port 22 includes an access opening 24 and a cylindrical contact surface 26. The access opening 24 permits light to pass to and from the MEMS die 18. A contact area 28 of the cylindrical contact surface 26 is shaped and sized to mechanically contact at least part of the partially spherical surface 12. The cylindrical contact surface 26 allows, while the partially spherical surface 12 is in contact with the contact area 28, linear motion of the spherical surface 12 along a Z axis and constrains the movement of the partially spherical surface 12 in a mutually orthogonal X linear axis and Y linear axis. The partially spherical surface 12 may, however, be moved along the Z axis and be rotated about the X, Y and Z axis while the partially spherical surface 12 is inserted within the cylindrical contact surface 26. The first photonic component 4 may be aligned by inserting the partially spherical surface within the cylindrical contact surface 26 and then linearly moved in the Z axis and rotated until an acceptable, desired or optimal alignment of the first photonic component 4 and the second photonic component 6 is achieved.

The partially spherical surface 12 of the first photonic component 4 is inserted into the access port 22 and positioned against the cylindrical contact surface 26. The partially spherical surface 12 forms a seal line 29 with the cylindrical contact surface 26. The seal line 29 is maintained as the partially spherical surface 12 is rotated and moved along the Z axis. The first photonic component 4 is thereby positioned into an acceptable or optimal alignment with the second photonic component 6. Once the first photonic component 4 and the second photonic component 6 are acceptably aligned, the first photonic component 4 and the second photonic component 6 are permanently assembled together by affixing or adhering the first photonic component 4 and the second photonic component 6 at and/or proximate to the seal line 29. The quality of an alignment may be evaluated by transmitting an optical signal between the optical fiber 8 and the MEMS die 18 and comparing a resulting received signal of this transmission with an expected received signal achievable when the first photonic component 4 and the second photonic component 6 are in a desirable or an optimal alignment. When the first photonic component 4 and the second photonic component 6 have achieved an acceptable, desirable or optimal alignment, the cylindrical contact surface 26 and the partially spherical surface 12 may be affixed together in a desired alignment by a suitable process or form of coupling known in the art, to include heating and cooling, adhering, adhering with epoxy, soldering, welding, solid phase welding, thermal compression welding, acoustic welding, spot welding, spark welding, laser welding, electrical welding and mechanical contact welding. An optional layer of material 30, such as an adhesive, solder, an epoxy, or a welding material used in welding such as Gold or one of a group of suitable weld filler materials or metals known in the art, may be deposited on either the partially spherical surface 12 or the cylindrical contact surface 26 prior to the insertion of the partially spherical surface 12 into the access port 22. The layer of material 30 is then used to affix, adhere, weld or solder the first photonic package 4 to or with the second photonic package 6.

An axis T is an optical axis of the first photonic component and/or the second photonic component or parts thereof, for example the MEMS die 18 or the optical fiber 8. The first photonic component 4 and the second photonic component 6 are substantially symmetric about the T optical axis.

Alternate variations of the photonic package 2 include additional or alternate photonic elements coupled with the first housing 10 of the first photonic component 4 or the second housing 20 of the second photonic component 6, to include an additional individual or a plurality of optical fibers or wave guides. One or more mirrors, prisms, wave guides, optical fibers, lenses, collimators, and other suitable photonic and optical devices and elements known in the art are additionally or alternately coupled to either or both the first housing and the second housing 20 in certain preferred variations of the photonic package. A coupled lens may be a suitable optical lens, spherical lens, aspherical lens, ball lens, GRIN lens, C-lens or lens system known in the art. Suitable optical fibers, planar wave guides, photonic crystal wave guides, and/or other suitable channels for optical signal and light energy transmission known in the art may be coupled with either or both the first housing 10 and the second housing 20. Additionally or alternatively, an optical or photonic element, or a plurality of optical or photonic elements, may be coupled to either photonic components 4 & 6, where each photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a lens, a C-lens, a lens system, a mirror, a flat mirror, a shaped mirror, a diffractive mirror, a grating plate or plates, a laser, a modulator, a photodiode, a VCSEL, a prism, and other suitable photonic or optical devices or elements known in the art.

A hole 32 of the cylindrical contact surface 26 allows for the material 30, such as a welding material, an adhesive, epoxy or solder, to be introduced to the contact area 28 of the cylindrical contact surface 26 before or after the partially spherical surface 12 is substantially in mechanical contact with the cylindrical contact surface 26. The material 30 may be introduced as the partially spherical surface 12 is being moved or aligned, and/or after the partially spherical surface 12 has been aligned as desired for assembly with the second photonic component 6. The assembly of the first photonic component 4 with the second photonic component 6 is advanced by the delivery of the material 30 through the hole 32 at a time chosen to support a desirable alignment of the first photonic component 4 and the second photonic component 6 at the seal line 29 where the spherical surface 12 mechanically touches the cylindrical contact surface 26.

In alternate preferred embodiments the first component 4 may have an ovoid, ellipsoid or other suitable convex surface that couples with the contact surface 26 of the second housing 20 in addition to as an alternative to the partially spherical surface.

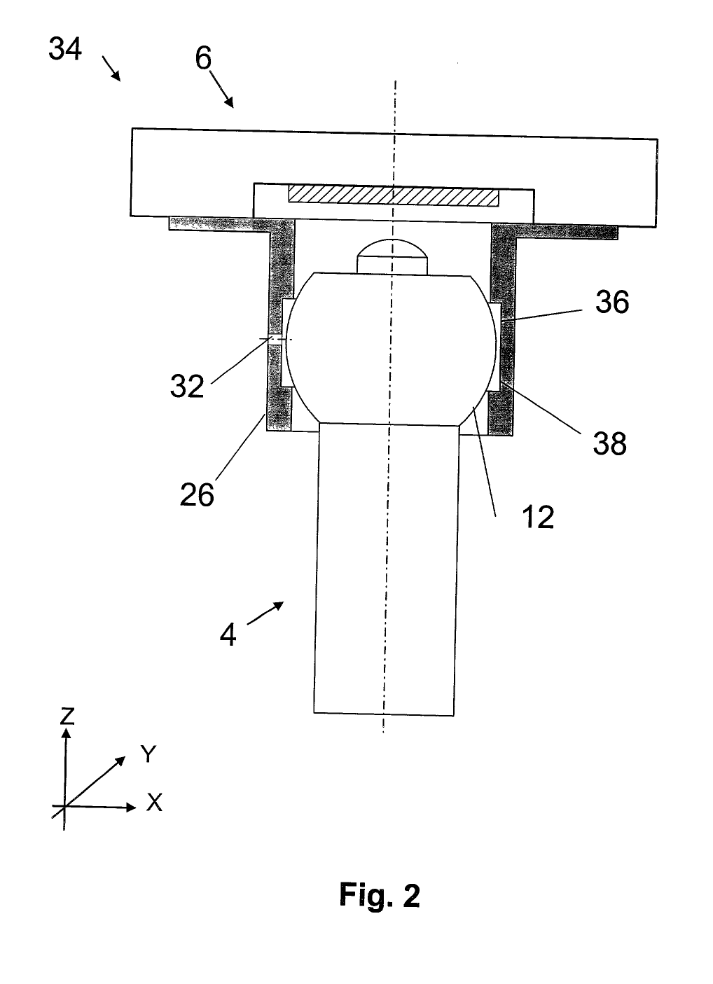

Referring now generally to the Figures and particularly to FIG. 2, FIG. 2 is a cross-sectional view of a second preferred embodiment of the present invention 34, or rigid photonic package 34, having the cylindrical contact surface 26 with an internal niche 36. The niche 36 may be sized and fitted with relatively planar sides 38 or convex sides, and the niche 36 may be lengthened or shortened to permit the partially spherical surface 12 a range of linear Z motion while held with the niche 36. The cylindrical contact surface 26 is made of a semi-flexible material that allows the partially spherical surface 12 to deform and expand to allow the partially spherical surface 12 to be inserted into the access port 22 and partially within the cylindrical contact surface 26 to be placed into the internal niche 36. Alternatively, the partially spherical surface 12, or both the partially spherical surface 12 and the cylindrical contact surface 26, may be made of a semi-flexible material that allows the partially spherical surface to be deformed and compressed to allow the partially spherical surface 12 to squeeze partially through the cylindrical contact surface 26 and into the niche 36. Once the partially spherical surface 12 is located within the niche 36 the first photonic component 4 is next positioned into a desirable orientation in relation to the second photonic component 6. The first photonic component 4 and the second photonic component 6 are then formed or affixed into a rigid photonic package 34 by welding or adhering, or another suitable assembly formation method known in the art.

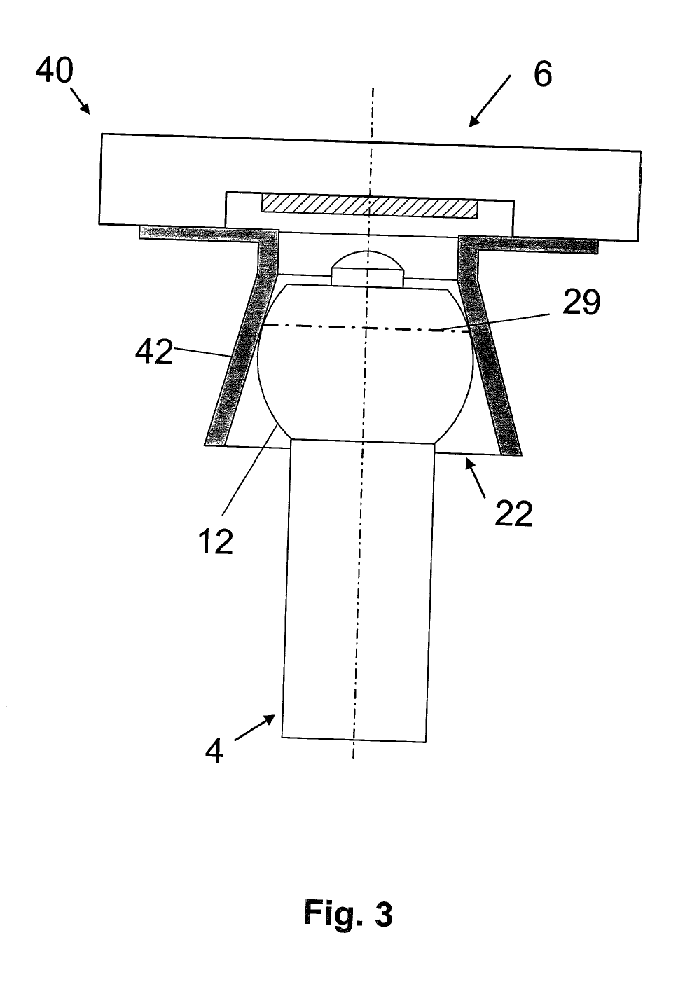

Referring now generally to the Figures and particularly to FIG. 3, FIG. 3 is a cross-sectional view of a third preferred embodiment of the present invention 40 having a conical contact surface 42. The partially spherical surface 12 of the first photonic component 4 is inserted into the access port 22 and positioned against the conical contact surface 42. The partially spherical surface 12 forms the seal line 29 with the conical contact surface 42. The seal line 29 is maintained as the partially spherical surface 12 is rotated and the first photonic component 4 is positioned into a desirable alignment with the second photonic component 6. Once the first photonic component 4 and the second photonic component 6 are acceptably aligned, the first photonic component 4 and the second photonic component 6 are permanently assembled together by affixing or adhering the first photonic component 4 and the second photonic component 6 at and/or proximate to the seal line 29. The first photonic component 4 and the second photonic component 6 may be affixed or adhered together by suitable methods and means known in the art, such as adhering, adhering with epoxy, soldering, welding, solid phase welding, thermal compression welding, acoustic welding, spot welding, spark welding, laser welding, electrical welding and mechanical contact welding.

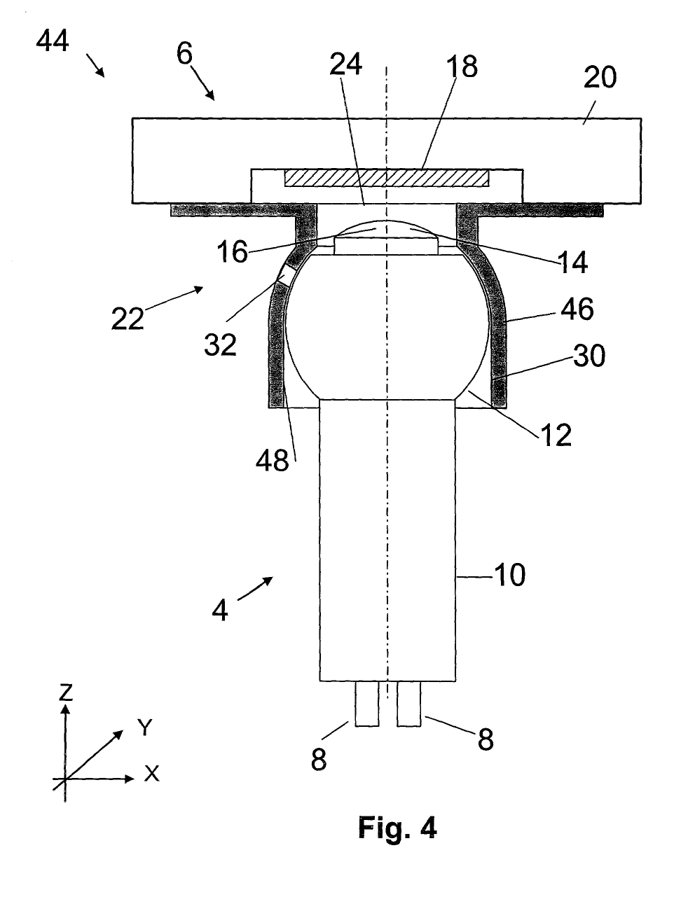

Referring now generally to the Figures and particularly to FIG. 4, FIG. 4 is a cross-sectional view of a fourth preferred embodiment of the present invention 44, or para-spherical photonic package 44, having a para-spherical contact surface 46. The partially spherical surface 12 is mechanically in contact with a contact area 48 of the para-spherical contact surface 46 during alignment and assembly of the para-spherical photonic package 44. The para-spherical contact surface 46 constrains, while the partially spherical surface 12 is partially or substantially fitted within the para-spherical contact surface 46, the movement of the partially spherical surface 12 in the X and Y linear axis in both directions and along the linear Z axis along the direction towards the second photonic component 6. The partially spherical surface 12 may, however, rotate about the X, Y and Z axis while the partially spherical surface 12 is in mechanical contact with the para-spherical contact surface 46. The first photonic component 4 may be aligned by placing or pressing the partially spherical surface 12 onto the para-spherical contact surface 46 and then rotating the first photonic component 4 until the desired alignment with the second photonic component 6 is achieved.

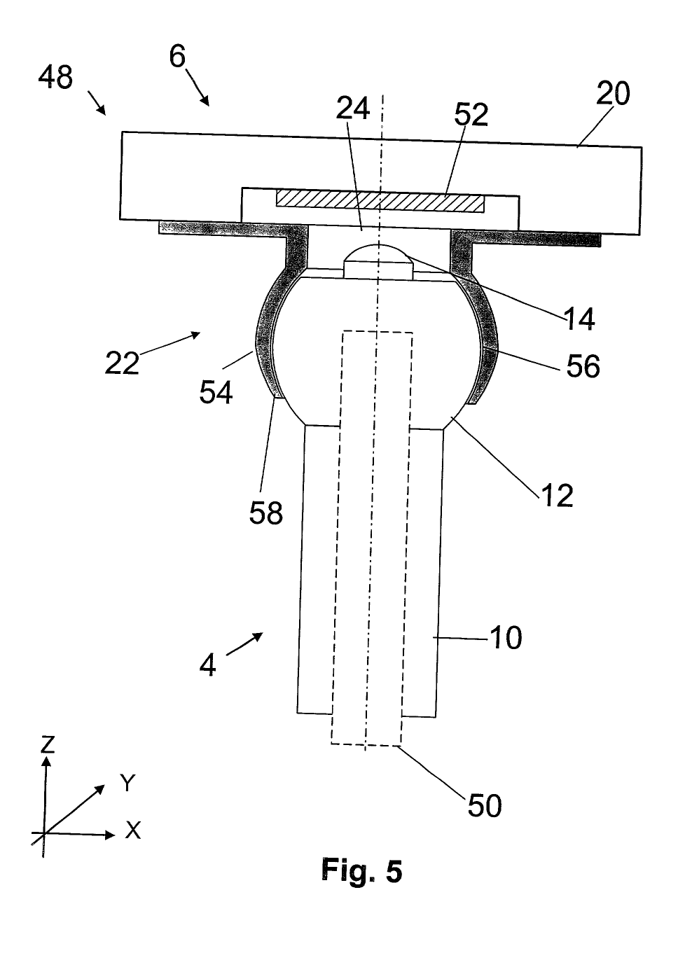

Referring now generally to the Figures and particularly to FIG. 5, FIG. 5 is a cross-section of a fifth preferred embodiment of the present invention 48, or spherical photonic package 48. The spherical photonic package 48 includes the first photonic component 4 having a first internal photonic element 50, the first housing 10 and the partially spherical surface 12. The partially spherical surface 12 includes the first photonic opening 14. The first photonic opening 14 permits light to pass to and from the first photonic element 50. The second photonic component 6 has a second internal photonic element 52, the second housing 20 and the access port 22. The second housing 20 is coupled to the second internal photonic element 52 and substantially encloses and protects the second internal photonic element 52. The access port 22 includes an access opening 24 and a contact surface 54. The access opening 24 permits light to pass to and from the second internal photonic element 52. The contact surface 54 is shaped and sized to mechanically contact and substantially or partly enclose at least part of the partially spherical surface 12. The contact surface 54 and the partially spherical surface 12 are sized and shaped to enable the partially spherical surface 12 to snap fit within the contact surface 54. The partially spherical surface 12 is mechanically in contact with a contact area 56 of the contact surface 54 during alignment and assembly of the spherical photonic package 48. The contact surface 54 constrains the movement of the partially spherical surface 12 in the X and Y linear axis and the linear Z axis while the partially spherical surface 12 is partially or substantially fitted within the contact surface 54. The partially spherical surface 12 may, however, rotate about the X, Y and Z axis while the partially spherical surface 12 is in mechanical contact with the concave spherical contact area 56. The first photonic component 4 may be aligned by placing or pressing the partially spherical surface 12 into the contact surface 54 and then rotating the first photonic component 4 until the desired alignment with the second photonic component 6 is achieved, and whereby a desired, preferred or optimized alignment of the first internal photonic element 50 and the second internal photonic element 52 is achieved. In certain alternate preferred embodiments, the partially spherical surface 12 may be partially ellipsoid or ovoid, and/or have at least one at least partially circular, elliptical or oval cross-section.

The contact surface 54 and/or the partially spherical surface 12 are made of semi-flexible material that deforms, expands or compresses sufficiently to enable the partially spherical surface 12 to be inserted partially into the access port 22 and to be constrained by the contact surface 54. The partially spherical surface 12 and the contact surface 54 may then be affixed together in a desired alignment by a suitable form of stationary coupling known in the art, to include heating and cooling, adhering, adhering with epoxy, soldering, welding, solid phase welding, thermal compression welding, acoustic welding, spot welding, spark welding, laser welding, electrical welding and mechanical contact welding. The contact surface 54 has an optional thinned edge 58 that promotes the welding of the contact surface 54 to the partially spherical surface 12 by electrical current welding techniques.

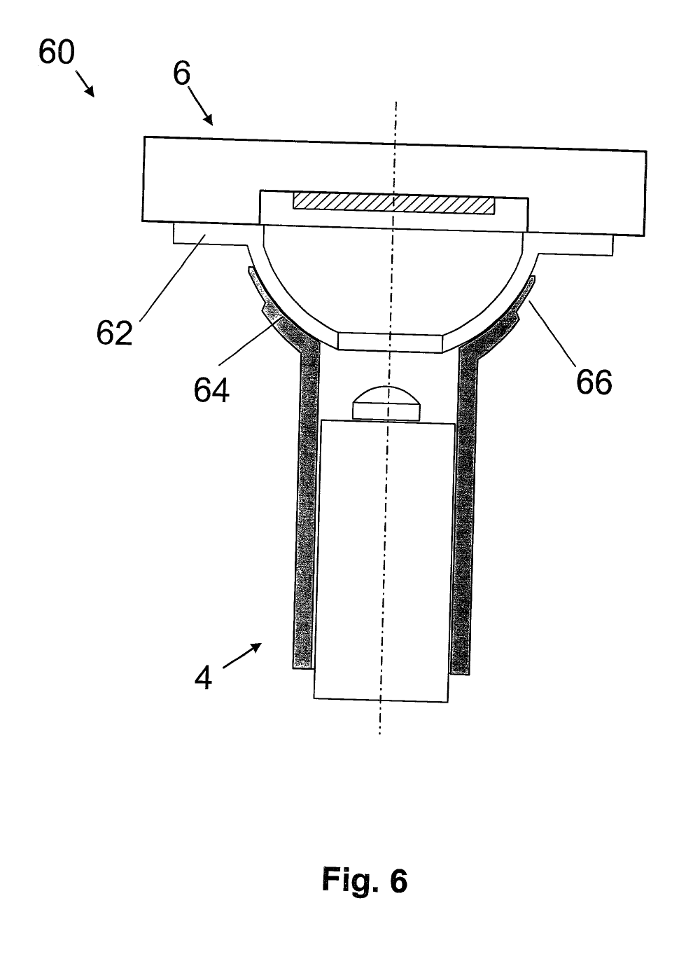

Referring now generally to the Figures and particularly to FIG. 6, FIG. 6 is a cross-sectional view of a sixth preferred embodiment 60 of the present invention having a second photonic component 6 with a partially spherical domed wall 62. A convex partially spherical surface 64 of the first photonic component 4 is shaped and sized to make mechanical contact with the spherical domed wall 62 and to allow the first photonic component 4 to be rotated by slidably positioning the convex partially spherical surface 64 about the spherical domed wall 62. The convex partially spherical surface 64 has a thinned edge 66 that improves the effectiveness of electrically welding the convex partially spherical surface 64 to the spherical domed wall 62. Alternatively, once the first photonic component 4 and the second photonic component 6 are desirably aligned, the convex partially spherical surface 64 and the partially spherical domed wall 62 may be affixed or adhered together by soldering, applying adherents, or another suitable affixing or welding technique known in the art.

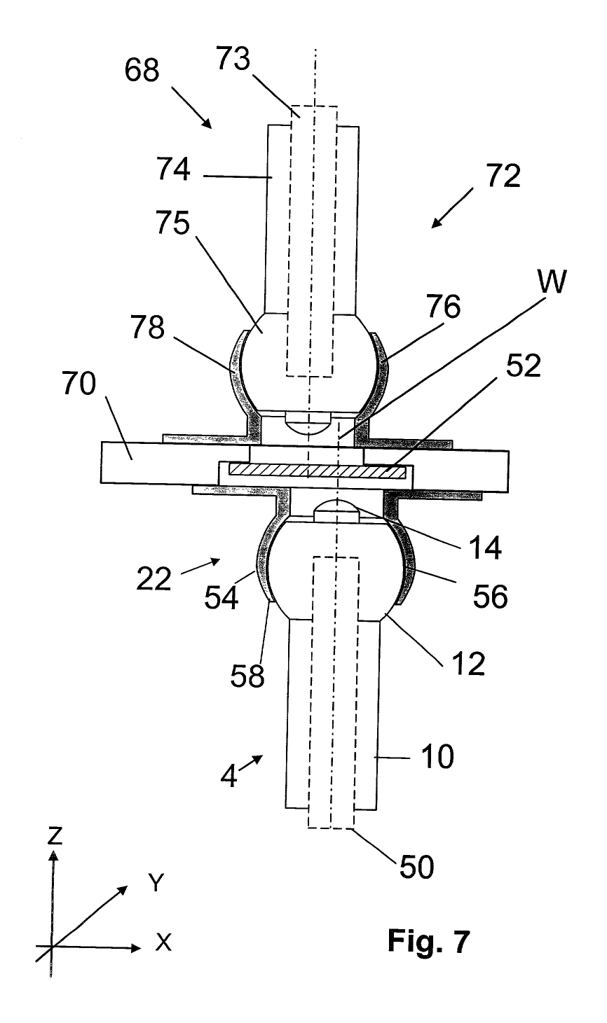

Referring now generally to the Figures and particularly to FIG. 7, FIG. 7 is a cross-section of a seventh preferred embodiment of the present invention 68, or dual spherical photonic package 68. The dual spherical photonic package 68 is or comprises an assembly of the first photonic component 4 of FIG. 1, a modified second photonic component 70 and a third photonic component 72. The modified second photonic 70 and the third photonic component 72 are asymmetric about an optical axis W of the first photonic component 4. The third photonic component 72 has a third internal photonic element 73, a third housing 74 and an ancillary partially spherical surface 75, or ancillary surface 75. The modified second photonic component 70 has the contact surface 54 and a second contact surface 76. The second contact surface 76 is shaped and sized to mechanically contact and substantially or partly enclose at least part of the ancillary surface 75. The second contact surface 76 and the ancillary surface 75 are sized and shaped to enable the ancillary surface 75 to snap fit within the second contact surface 76. The ancillary surface 75 is mechanically in contact with a contact area 78 of the second contact surface 76 during alignment and assembly of the dual spherical photonic package 68. The second contact surface 76 constrains the movement of the ancillary surface 75 in the X and Y linear axis and the linear Z axis while ancillary surface 75 is partially or substantially fitted within the second contact surface 76. The ancillary surface 75 may, however, rotate about the X, Y and Z axis while the ancillary surface 75 is in mechanical contact with the concave spherical contact area 78. The third photonic component 72 may be aligned by placing or pressing the ancillary surface 75 into the second contact surface 76 and then rotating the third photonic component 72 until the desired alignment between the modified second photonic component 70 is achieved, whereby a desired, preferred or optimized alignment of the second internal photonic element 52 and the third internal photonic element 73 is achieved. In certain alternate preferred embodiments, the ancillary surface 75 may be partially ellipsoid or ovoid, and/or have at least one at least partially circular, elliptical or oval cross-section.

The present invention has been described in conjunction with the preferred embodiments. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense. As noted above, the present invention is applicable to the use, operation, structure and fabrication of a number of different photonic component assemblies. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications, devices and methods.

We claim:

1. A feature that is useful to align and assemble a photonic package, the photonic package having a first photonic component and a second photonic component, the feature comprising:
the first photonic component, the first photonic component having a first housing, the first housing having a partially spherical surface for providing mechanical contact with the second component; and
the second photonic component, the second photonic component having a second housing, the second housing having a contact surface, the contact surface for providing mechanical contact with the partially spherical surface along at least one circular contact line, whereby the feature enables the alignment and affixing of the first photonic component with the second photonic component while maintaining mechanical contact of the first photonic component with the second photonic component.

2. The feature of claim 1, wherein the first photonic component is substantially symmetric with respect to an optical axis of the first component.

3. The feature of claim 2, wherein the second photonic component is substantially symmetric with respect to at least one optical axis of the first photonic component.

4. The feature of claim 1, wherein the first photonic component is asymmetric with respect to an optical axis of the first component.

5. The feature of claim 4, wherein the second photonic component is asymmetric with respect to at least one optical axis of the first photonic component.

6. The feature of claim 1, wherein the contact surface is comprised within a cylindrical channel.

7. The feature of claim 6, wherein the cylindrical surface has a niche, the niche for constraining the linear motion of the partially spherical surface when the partially spherical surface is inserted into the cylindrical channel.

8. The feature of claim 7, wherein the niche is dimensioned to allow a range of motion of the partially spherical surface along one linear axis.

9. The feature of claim 1, wherein the contact surface is comprised within a cone.

10. The feature of claim 1, wherein the first photonic component further comprises at least one photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

11. The feature of claim 1, wherein the second photonic component further comprises a second photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

12. The feature of claim 11, wherein the first photonic component further comprises a first photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

13. The feature of claim 1, wherein the feature further comprises a layer of a material, the layer of material for affixing the partially spherical surface to the contact surface, and the layer of material substantially positioned between the partially spherical surface and the contact surface, and the material useful for affixing the partially spherical surface to the contact surface.

14. The feature of claim 13, wherein the layer of material is selected from the group consisting of adhesive, welding material, solder and epoxy.

15. The feature of claim 1, wherein the first housing has a thinned edge, the thinned edge for conducting an electrical current, and the thinned edge brazing with the contact surface while conducting the electrical current, whereby the first housing is affixed to the second photonic component.

16. The feature of claim 1, wherein the second housing has a thinned edge.

17. The feature of claim 1, wherein the first housing comprises at least one hole, the hole for use in delivering a material useful for forming the photonic package.

18. The feature of claim 17, wherein the material is selected from the group consisting of adhesive, welding material, solder and epoxy.

19. The feature of claim 1, wherein the first photonic component and the second photonic component are affixed together by a process selected from the group consisting of adhering, adhering with epoxy, soldering, welding, solid phase welding, thermal compression welding, acoustic welding, spot welding, spark welding, laser welding, electrical welding and mechanical contact welding.

20. The feature of claim 1, wherein the second photonic component further comprises a plurality of photonic elements, each photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

21. The feature of claim one, wherein the feature further comprises:
a third photonic component, the third photonic component having a third housing, the third housing having an ancillary partially spherical surface for providing mechanical contact with the second component; and
the second housing of the second photonic component having a second contact surface, the second contact surface for providing mechanical contact with the ancillary partially spherical surface of the third photonic component along at least one circular contact line, whereby the feature enables the alignment and affixing of the third photonic component with the second photonic component while maintaining mechanical contact of the third photonic component with the second photonic component.

22. A feature that is useful to align and assemble a photonic package, the photonic package having a first photonic component and a second photonic component, the feature comprising:
the first photonic component, the first photonic component having a first housing, the first housing having a partially spherical surface for providing mechanical contact with the second component; and
the second photonic component, the second photonic component having a second housing, the second housing having a contact surface, the contact surface for providing mechanical contact of a contact area of the contact surface with the partially spherical surface, whereby the feature enables the alignment and affixing of the first photonic component with the second photonic component while maintaining mechanical contact of the first photonic component with the second photonic component.

23. The feature of claim 22, wherein the first photonic component further comprises a first photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

24. The feature of claim 22, wherein the second photonic component further comprises a second photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

25. The feature of claim 24, wherein the first photonic component further comprises a first photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

26. A feature that is useful to align and assemble a photonic package, the photonic package having a first photonic component and a second photonic component, the feature comprising:
the first photonic component, the first photonic component having a domed wall, the domed wall having a partially spherical convex surface for providing mechanical contact with the second component; and
the second photonic component, the second photonic component having a second housing, the second housing having a partially spherical concave contact surface, the partially spherical concave contact surface for providing mechanical contact of a contact area of the partially spherical concave contact surface with the partially spherical convex surface of the domed wall, whereby the feature enables the alignment and affixing of the first photonic component with the second photonic component while maintaining mechanical contact of the first photonic component with the second photonic component.

27. The feature of claim 26, wherein the first photonic component further comprises a first photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

28. The feature of claim 26, wherein the second photonic component further comprises a second photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

29. The feature of claim 28, wherein the first photonic component further comprises a first photonic element selected from the group consisting of a wave guide, a planar wave guide, a photonic crystal wave guide, a diffraction wave guide grating, an optical fiber, a collimator, a lens, a diffractive lens, an optical lens, a spherical lens, an aspherical lens, a ball lens, a GRIN lens, a C-lens, a lens system, a mirror, a flat mirror, a shaped mirror, a diffractive mirror, a grating plate or plates, a laser, a modulator, a photodiode, a VCSEL, and a prism.

30. A method of forming a photonic package by aligning and assembling two photonic components together, the method comprising:
providing a first photonic component, the first photonic component having a first housing, the first housing having a convex surface for providing mechanical contact with the second component;
providing a second photonic component, the second photonic component having a second housing, the second housing having a contact surface, the contact surface for providing mechanical contact with the convex surface along at least one contact line;
placing the partially spherical surface at least partially into mechanical contact with the contact surface;
aligning the first photonic component into a desired alignment with the second photonic component while maintaining the mechanical contact of the partially spherical surface with the contact surface; and
affixing the first photonic component and the second photonic component while the first photonic component and the second photonic component are in a desired alignment, whereby the invented method enables the alignment and affixing of the first photonic component with the second photonic component while maintaining mechanical contact of the first photonic component with the second photonic component.

31. The method of claim 30, wherein the convex surface is at least partially shaped from a shape selected from the group of a sphere, an ovoid or an ellipsoid.

32. The method of claim 30, wherein the contact surface is comprised within an at least partially cylindrical channel.

33. The method of claim 30, wherein the contact surface is comprised within an at least partially conical channel.

34. The method of claim 30, wherein the contact surface has an internal niche for constraining the movement of the convex surface in at least one linear degree of freedom.

35. The method of claim 30, wherein the photonic package is formed by affixing the first photonic component and the second photonic component together by a process selected from the group consisting of adhering, adhering with epoxy, soldering, welding, solid phase welding, thermal compression welding, acoustic welding, spot welding, spark welding, laser welding, electrical welding and mechanical contact welding.
